(19) United States
(12) Patent Application Publication
(10) Pub. No.: US 2016/0004318 A1
(43) Pub. Date: Jan. 7, 2016

(54) SYSTEM AND METHOD OF TOUCH-FREE OPERATION OF A PICTURE ARCHIVING AND COMMUNICATION SYSTEM

(71) Applicant: PACSPoint Inc., Charlottesville, VA (US)

(72) Inventors: Jose Morey, Charlottesville, VA (US); Peter Stoll, Lansdale, PA (US)

(21) Appl. No.: 14/597,871

(22) Filed: Jan. 15, 2015

Related U.S. Application Data
(63) Continuation-in-part of application No. 14/323,266, filed on Jul. 3, 2014.

(51) Int. Cl. G06F 3/01

(52) U.S. Cl. CPC G06F 3/017; G06F 3/015

(57) ABSTRACT

A method of controlling a PACS image viewer using a system comprising one or more sensors configured to interpret muscle electrical activity as hand gestures is described. The method comprises accepting user input from the one or more sensors comprising hand motion, vector, and gesture information, sending such information to the processor according to a frame rate, and translating such information into a virtual input by the processor according to a set of computer-executable instructions, wherein the virtual input is configured to control a PACS image viewer. The virtual input simulates one or more key strokes, mouse clicks, or cursor movements and allows a physician to use a PACS image viewer without using any hand-operated equipment such as a mouse, trackpad, or keyboard. In this way, the physician may scroll through images using the PACS image viewer while maintaining a sterile environment.

### CROSS-REFERENCE TO RELATED APPLICATIONS

The present application claims priority to and is a Continuation-in-Part (CIP) of U.S. patent application Ser. No. 14/323,266, filed Jul. 3, 2014, the disclosure of which is hereby incorporated by reference in its entirety.

### BACKGROUND OF THE INVENTION

1. Field of the Invention

The present disclosure relates to systems and methods of computer-implemented touch-free interfacing with a Picture Archiving and Communication System (PACS) image viewing software. Embodiments of the present disclosure relate to systems and methods that use a sensor configured for detecting hand gestures in combination with software for translating the hand gestures into specific controls for controlling a PACS image viewer. In a specific embodiment, the sensor detects hand gestures through muscle electrical activity.

2. Description of Related Art

In healthcare environments, it is very important to maintain sterility while interacting with patients especially during surgical procedures. In many cases, it is necessary to be able to use PACS while maintaining sterility. Presently, this is achieved in one of two ways. The physician can physically interact with a computer on which PACS is stored through direct contact with a mouse and/or keyboard, then resterilize. Alternatively, the physician can indirectly use PACS by instructing an assistant to physically interact with the computer and control PACS according to the physician's needs. Both of these methods are inefficient in their use of time and human resources.

There exist numerous ways of interacting with computers with contact-free methods, some of which involve medical settings. However, many of these involve interacting with operating system-level functions, like cursor movement and mouse clicks. While it is possible to use a computer in this manner, it is neither easy nor efficient, as the accuracy of current motion-tracking is not sufficient for the fine control needed to interact with GUIs intended for mouse control.

For example, U.S. Pat. No. 7,698,002 B2 describes a gesture-based way of controlling a medical device, specifically a pulse oximeter. It compares any received gestures with gestures in its database, then executes the commands associated with the appropriate gesture from its database. International Patent Application Publication No. WO 2013035001 A2 uses a gesture-based interface to control a group of medical devices. Gesture tracking uses markers on the user. U.S. Patent Application Publication No. 20110304650 A1 describes a generic user interface which receives motion data from a gesture-based controller, recognizing screen coordinates as extensions of objects pointed at it, while International Patent Application Publication No. WO 2007137093 A2 describes contact-free interaction with a computer for medical purposes. It uses an instrument with a tracking device that is visible to a motion-based controller and foot pedals that map to mouse clicks. In this way, the operator is able to control a cursor on a computer without physically coming into contact with the computer. However, despite these attempts, there remains a need for a touch-free method and system of allowing a physician to access medical records while maintaining a sterile environment.

### SUMMARY OF THE INVENTION

To this end, embodiments of the invention provide computer-implemented methods and software which obviate the need for a physician to physically interact with a computer or computer-accessory used for input such as a mouse or keyboard, while simultaneously providing access to and control of a picture archiving and communication system (PACS). The software and methods thus allow a physician to maintain a sterile environment while accessing the picture archiving and communication system (PACS) system. The methods may rely on one or more motion sensing input devices to detect hand gestures. Embodiments also include systems for providing access to the picture archiving and communication system (PACS) system which use one or more motion sensing input devices to detect hand gestures. The motion-sensing input devices may include computer-vision systems which detect hand movements or gestures, or sensors which directly detect muscle electrical activity such as EMG sensors. The motion sensing input devices may also include one or more of a three-axis gyroscope, three-axis accelerometer, and a three-axis magnetometer. The motion sensing input devices may also include other sensors known in the art. Embodiments of the invention may also include methods of performing medical procedures that require access to the picture archiving and communication system (PACS) while maintaining a sterile environment.

According to embodiments of the invention, software is provided in the form of a computer-readable storage device comprising computer-executable instructions configured to direct a first processing module to: (a) receive hand position, vector, or gesture information according to a specified frame rate, (b) translate the hand position, vector, or gesture information into one or more key strokes, mouse clicks, scrolling, or cursor movements, and (c) navigate, annotate, or modify one or more images in a picture archiving and communication system (PACS) by instructing the system that the one or more key strokes, mouse clicks, scrolling, or cursor movements have been performed. In embodiments, the hand gesture information is interpreted from information received from one or more sensors each of which are capable of measuring muscle electrical activity. Further, it is understood that in the context of this invention the software provided in the form of a computer-readable storage device can be presented to users as a Software As a Service (SAS) type product where the software is stored in one location and accessed remotely by users over the internet.

Embodiments of the invention provide a computer-implemented method of controlling a picture archiving and communication system (PACS). The computer-implemented method obviates the need for a user to have physical contact with a computer or computer accessory, thus allowing a physician to maintain sterility during medical procedures while providing touch-free access and control of images on the picture archiving and communication system (PACS). In one embodiment, the computer-implemented method comprises: (a) receiving hand position, vector, or gesture information according to a specified frame rate, (b) translating the hand position, vector, or gesture information into one or more key strokes, mouse clicks, scrolling, or cursor movements, and (c) navigating, annotating, or modifying one or more images in a picture archiving and communication system (PACS) by instructing the system that the one or more key strokes, mouse clicks, scrolling, or cursor movements have been performed. In embodiments, the receiving, translating, and navigating steps are performed through a first processing module. In embodiments, the hand gesture information is interpreted from information received from one or more sensors each of which are capable of measuring muscle electrical activity.

In embodiments, the one or more sensors each of which are capable of measuring muscle electrical activity are EMG sensors, and the hand position or vector information is interpreted from information received from at least one of a three-axis gyroscope, three-axis accelerometer, and a three-axis magnetometer. In embodiments, the hand position, vector, or gesture information is interpreted by a second processing module.

In embodiments, the translating step is performed by a set of computer-executable instructions providing a first class and a second class, and the hand position, vector, or gesture information of a frame is received by the first class and analyzed by the second class. In embodiments, the second class is associated with a user-selected mode comprising keyboard input, mouse position, scrolling, or mouse clicks. In embodiments, the second class executes one or more key strokes, mouse clicks, scrolling, or cursor movements based on the analysis of the data received by the first class.

Embodiments also provide a method of guiding a needle or catheter within a patient's body. In one embodiment, the method comprises (a) imaging a region of interest of a patient's body with one or more imaging modality to obtain one or more images of the region of interest, (b) accessing the one or more images in a picture archiving and communication system (PACS), (c) navigating the one or more images in the PACS system to locate an image or images showing a position of a needle or a catheter within the patient's body, wherein the navigating is performed using one or more EMG sensors, (d) moving the needle or catheter to another position within the patient's body using the one or more images in the PACS system as a guide to desired positioning. In embodiments, the navigating is also performed using at least one of a three-axis gyroscope, three-axis accelerometer, and a three-axis magnetometer.

In embodiments, the navigating of the one or more images involves one or more of selecting one or more images, selecting a series of images, changing image series, scrolling through image stacks, scrolling through image series stacks, moving a cursor, annotating an image or images, or accessing a tool bar. Embodiments include navigating while maintaining a sterile environment for the patient by having no physical interaction with a computer, or annotating involving electronically marking the one or more images without physically interacting with a computer.

In embodiments, the one or more imaging modality is chosen from one or more of MRI (magnetic resonance imaging), PET (positron emission tomography), CT (computed tomography), X-ray, Ultrasound, Photoacoustic imaging, Fluoroscopy, Echocardiography, or SPECT (single-photon emission computed tomography).

### BRIEF DESCRIPTION OF THE DRAWINGS

The accompanying drawings illustrate certain aspects of embodiments of the present invention, and should not be used to limit the invention. Together with the written description the drawings serve to explain certain principles of the invention.

FIG. 1 is a schematic diagram of a system embodiment of this disclosure that includes a LEAP controller.

FIG. 2 is a schematic diagram of a method embodiment of this disclosure that includes use of a LEAP controller.

FIGS. 3A and 3B are schematic diagrams of a method embodiment of this disclosure showing control of a PACS system using a LEAP controller.

FIG. 4 is a schematic diagram of a system embodiment of this disclosure that includes a MYO controller.

FIG. 5 is a schematic diagram of a method embodiment of this disclosure that includes use of a MYO controller.

FIGS. 6A and 6B are schematic diagrams of a method embodiment of this disclosure showing control of a PACS system using a MYO controller.

### DETAILED DESCRIPTION OF VARIOUS EMBODIMENTS OF THE INVENTION

Reference will now be made in detail to various exemplary embodiments of the invention. It is to be understood that the following discussion of exemplary embodiments is not intended as a limitation on the invention. Rather, the following discussion is provided to give the reader a more detailed understanding of certain aspects and features of the invention.

One embodiment of a system of this disclosure uses one or more motion sensing input devices to detect hand gestures. The motion sensing input devices may comprise one or more infrared (IR) cameras. For example, a LEAP Motion controller may be used. The LEAP Motion controller is a small USB device containing two upwards-facing stereoscopic IR cameras, which establish an inverted pyramid-shaped detection region of height approximately equal to 2 feet above the device. The software controlling the device has an API (application programming interface) with support for up to six programming languages. The API v1 contains support for finger tracking as well as gesture tracking. A new API v2 has recently been released, providing tracking for individual joints. However, other motion sensing input devices could also be used or modified as needed, such as KINECT (MICROSOFT), PLAYSTATION Eye, NINTENDO Wii or ASUS Xtion PRO. The system typically comprises one or more remote sensing input devices connected to a processor. The processor is further connected to a display and has access to a memory comprising a set of computer-executable instructions for performing algorithms which translate vectors and gestures into cursor movement, mouse clicks, and keystrokes. An exemplary algorithm would observe the position of the index fingertip with respect to the LEAP Motion controller's detection plane along the x and y axes and move the cursor to the corresponding location on the display. It would also observe any programmed gestures, such as screen taps and key taps, which the LEAP software handles, custom gestures, or even user-defined gestures, and carry out an action based on the mapping of these gestures to PACS functions.

In other embodiments, a system of this disclosure may comprise a motion sensing input device that may detect hand gestures through sensors which are capable of measuring muscle electrical activity. In one embodiment, the sensors which are capable of measuring muscle electrical activity are EMG sensors. The EMG sensors may be comprised of medical grade stainless steel. In one embodiment the EMG sensors are capacitive electromyography (cEMG) sensors. The EMG sensors may be operably connected to a computer processor configured to interpret muscle movements as hand gestures through one or more algorithms embodied in software. The EMG sensors may be worn by a user on a wrist or forearm and measure the electrical activity of skeletal muscles in the wrist or forearm. Such electrical activity may have characteristic “signatures” corresponding to hand movements. The characteristic electrical signals may be interpreted by one or more algorithms in combination with a computer processor to correspond with specific hand gestures. Alternatively or in addition to the EMG sensors, the motion-sensing input device may detect hand position or vector information and arm movements through a three-axis gyroscope, a three-axis accelerometer, and/or a three-axis magnetometer. An exemplary commercial embodiment of a system incorporating EMG sensors, a three-axis gyroscope, a three-axis accelerometer, and/or a three-axis magnetometer is the MYO muscle-based motion-sensing armband system developed by Thalmic Labs Inc. of Waterloo, Ontario. The MYO system and related technology is described in U.S. Patent Application Publication Nos. 20140240223, 20140198034, 20140198035, 20140249397, 20140240223, 20140240103, each of which is hereby incorporated by reference in its entirety. The MYO armband is worn on the forearm and is used to detect muscle stimulation as well as provide acceleration and orientation data. When the EMG detects muscle movements it sends data to a processor which analyzes the data; specific muscle movements are interpreted as a pose through algorithms and each pose can be used as part of a gesture recognition system, while the acceleration and orientation data is provided in the form of 3D vectors. In an exemplary embodiment, computer-executable instructions interpret hand gesture and 3D vector information from the MYO controller to produce common computer inputs such as keystrokes and mouse movement without the use of a mouse or keyboard. These inputs are designed to be used in conjunction with medical DICOM imaging programs such as GE PACS. In embodiments, the computer-executable instructions are coded in Python v2.7 and C++ and use several standard Python modules as well as the C++ developers kit provided with the MYO.

In other embodiments, the motion sensing input device may detect hand gestures or arm movements through other types of sensor technologies known in the art. These include sensors such as elastomeric pressure sensors, tactile sensors, optical goniometry sensors, resistance sensors, proximity sensors, tilt sensors, inertia sensors, and accelerometers, which may optionally be embedded in gloves worn by a user of the software. Specific examples of such gloves include the ACCELOGLOVE (AnthroTronix, Inc., Silver Spring, Md.), 5DT's Data Glove, and the CYBERGLOVE (CyberGlove Systems LLC, San Jose, Calif.). However, such gloves are not preferred embodiments for delicate medical applications. Usage of such embodiments is preferably limited to procedures where minimal hand and finger dexterity is required. Preferred are sensor systems which don't require hand-worn sensors such as computer vision-based systems and systems which measure muscle electrical activity. Other hands-free systems may include laser-based systems such as “Mouseless” developed by Pranav Mistry at MIT which uses an infrared LASER beam and an infrared camera, or ST Microelectronics' (Geneva, Switzerland) infrared laser-based systems, or photodetection-based systems such as those described in U.S. Patent Application Publication Nos. 2013/0334398 and 2013/0162520.

In embodiments in which a LEAP controller is used, the computer-executable instructions may be set up as a two-class program that contains a Listener Class and a Controller class. The Listener class is customized to receive the information from the controller class and then act on the information received. The design of the Listener class was done with blocks of if statements checking for various conditions in the information received from the controller class, and then modifying the results of that input as needed. The computer-executable instructions may report coordinates of objects in the field of view of the motion sensing input device using the x, y, and z axis with the middle of the input device representing the origin point. The computer-executable instructions use the x and y coordinates delivered by the input device and use an algorithm to determine where the cursor should move on a computer screen. The computer-executable instructions also allow for configuration of a group of hand gestures that can be used as additional inputs. These gestures have been configured to allow a user to operate PACS software using a combination of the gestures available.

Alternatively, for MYO-based systems, the structure of the program is set up so that a MYO Hub class collects the data on each frame from the MYO and has several worker classes that represent the various modes. Depending on the mode selected, that mode's worker class analyses the data provided by the Hub class and performs whatever action the criteria from the data calls for. PACS Point is intended to run in the background while a user operates imaging software and error handling is conducted in an effort to minimize any interruption. If a frame of data generates an error PACS Point passes over that frame and waits until the next non-error producing frame is available to produce any actions. When the user decides to close PACS Point, all processes created by the program are identified by their PID and terminated using the standard sys module of Python. If this fails for any reason the os.kill function is called which will kill the PACS Point process and child processes it created. This is done in order to make sure that no left over virtual keystrokes are being read by the operating system.

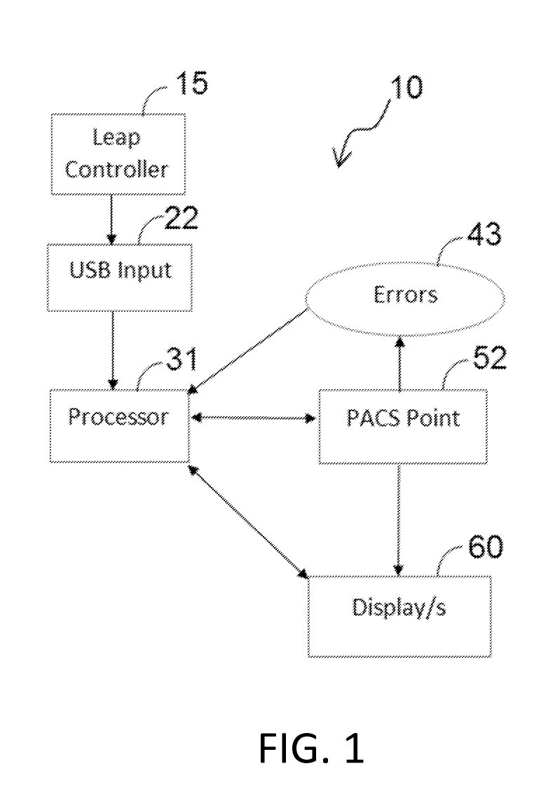

Turning now to the figures, FIG. 1 shows a specific embodiment of such a system 10 where a motion sensing input device, which in this case is a LEAP Motion controller 15 is connected to a computer via USB interface 22. This USB interface 22 is accessible to a processor 31, which receives data from the interface 22, display(s) 60, PACS Point program 52 (also referred to herein as a set of computer-executable or computer-readable instructions which may be used interchangeably with “PACS Point program” or “PACS Point”), and errors 43 generated by the PACS Point program. PACS Point program 52 consists of computer-readable instructions that can be executed by the processor 31, which affect operations at the OS level, as well as the display 60. The computer-readable instructions can be programmed in any suitable programming language, including JavaScript, C#, C++, Java, Python, and Objective C.

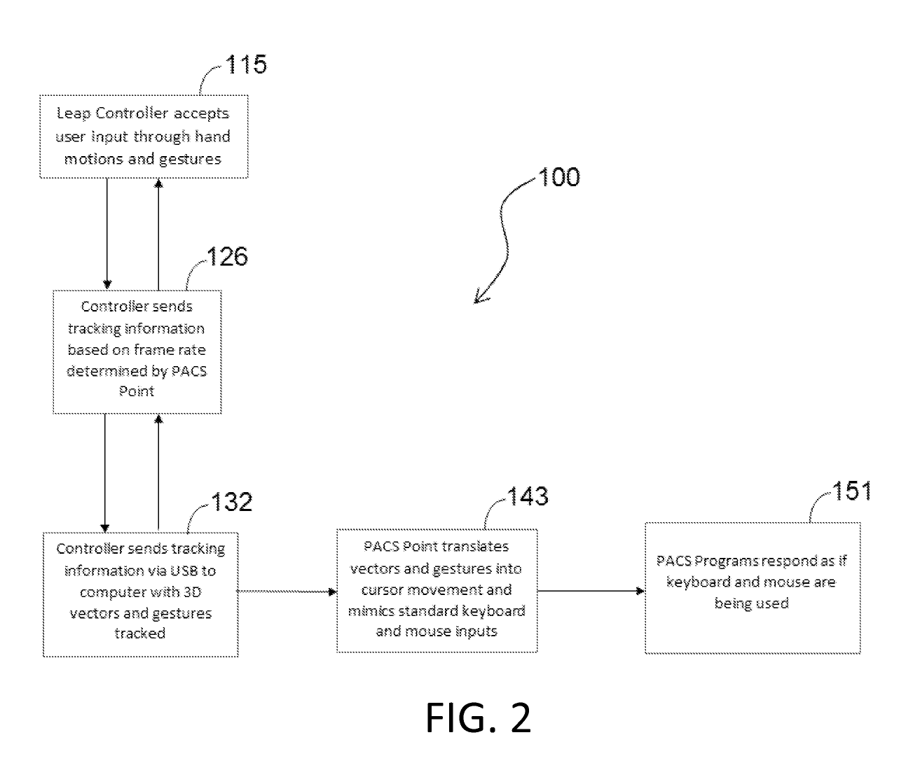

FIG. 2 shows software-level operations 100 of an embodiment of the disclosure. The LEAP Motion controller accepts user input through hand motions and gestures 115. Associated data is sent via USB to a computer as 3D vectors and gestures 132. Example schemes of this tracking include an index-to-thumb pinch for zooming, two hands moving toward/away from each other for zooming, five fingers spread out moving up or down for scrolling, one finger screen tap click for mouse click, two finger screen tap click for mouse click, three finger screen tap click for mouse click and hold, one hand grab for mouse click and hold, one finger keytap for right mouse click, one finger or thumb circle for scrolling (clockwise or counterclockwise), one hand swipe left or right for keyboard input for next series, and one finger movement for cursor movement. This tracking information is based on a frame rate determined by PACS Point 126. Typically, the highest frame rate possible for a particular component of the system is preferable. PACS Point translates vectors and gestures into cursor movement, mouse clicks, keystrokes, etc., which are emulated at the OS level 143. PACS programs then respond as if keyboard and mouse are used 151.

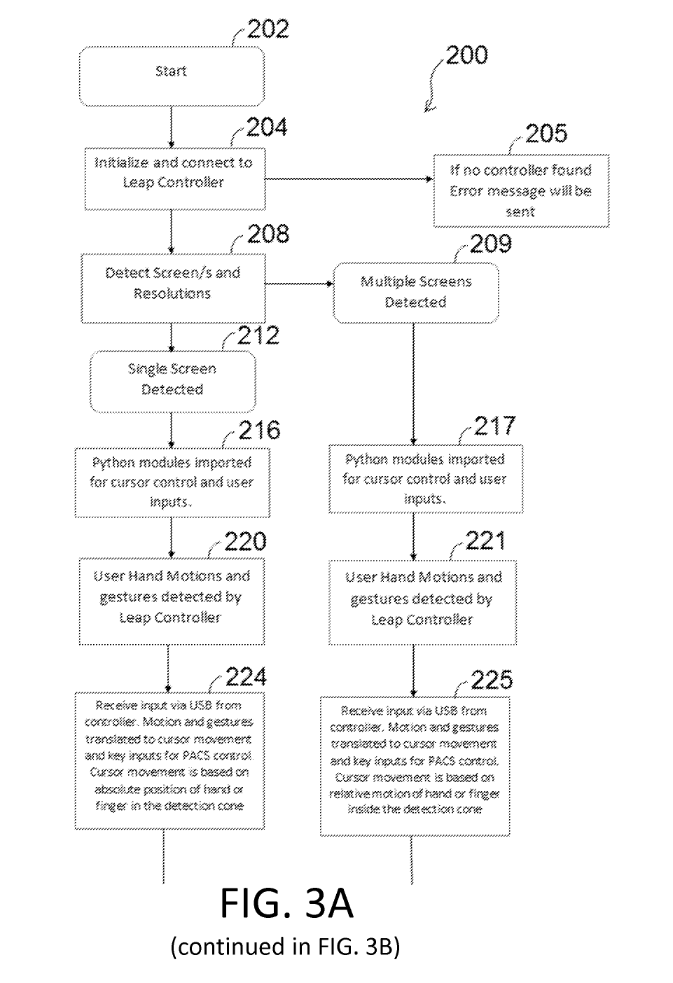

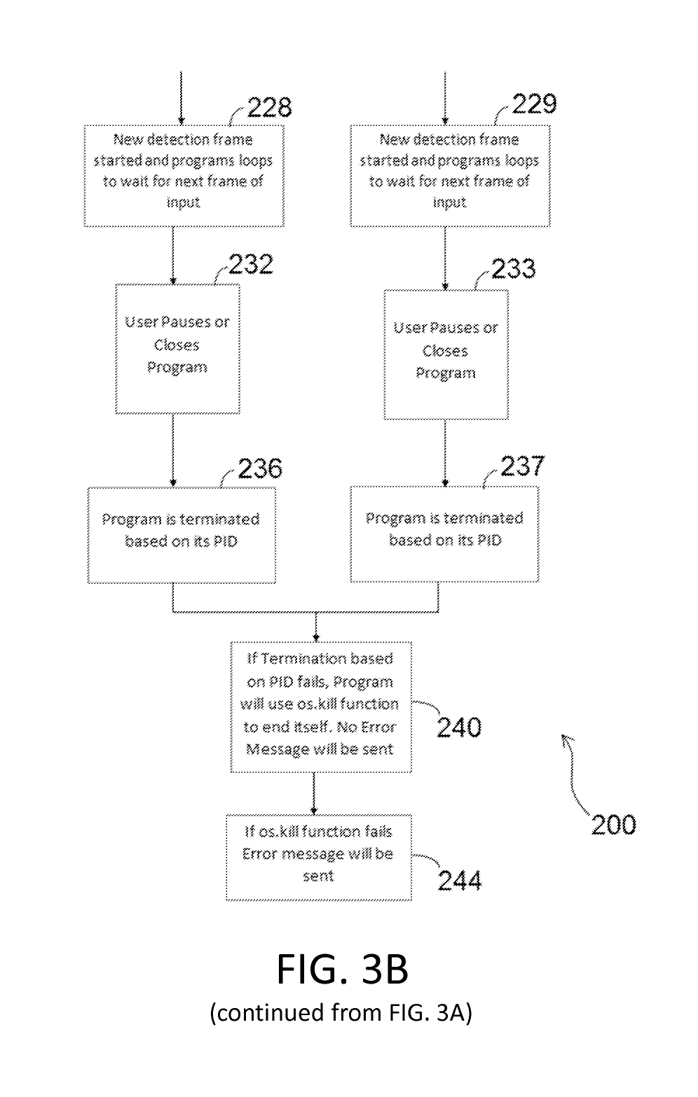

FIGS. 3A and 3B show control flow 200 of an embodiment of a method of this disclosure which may be embodied in a computer program or application. The control flow begins at reference numeral 202. The program is initialized and a connection to the LEAP Motion controller is made 204. If no valid controller is found, an error message is sent 205. The controller is configured by the program, and the program is enabled to receive events from the controller. The number of screen(s) is detected 208, which is important in the calculation of cursor movement because as multiple displays are connected, the display dimensions become less similar to the LEAP Controller's detection area dimensions, so an alternate cursor control scheme should be used to ensure full coverage of both displays. The control flow then may be executed in two branches, depending on whether a single screen 212 or multiple screens 209 are detected; even reference numerals represent the branch where a single screen is detected, and odd reference numerals represent the branch where multiple screens are detected. Necessary program instructions are imported to allow OS level control over cursor movement, mouse clicks, keystrokes, etc. 216, 217.

The program instruction(s) are imported according to the following lists, wherein step 216 imports the instruction(s) from List 1, and step 217 imports the instruction(s) from List 2.

| List 1 | List 2 |
|---|---|
| LEAP | LEAP |
| Autopy | Win32api |
| Win32api | Win32con |
| Win32con | Os |
| Os | Sys |
| Sys | Wxpython |
| Wxpython | Pygame |
| Pygame | PIL |
| PIL | |

Win32con is used to provide the key constants used by Win32api to mimic keyboard events. Win32api (also called PyWin) is used to contain the program in a “wrapper”, which allows the program to run as a service on Windows. This module is also involved in the installation of the program to any Windows computer that may use it. AutoPy is used for a variety of purposes, such as allowing the program to detect the size of the monitor that the program will be running on in order to adjust the algorithm used in positioning the cursor on the screen. Additionally, AutoPy is linked to the recognized LEAP gestures and allows the program to simulate keyboard or mouse inputs that are used to interact with PACS imaging applications. Sys provides system-specific parameters and functions and Os provides portable way of using operating system dependent functionality. WxPython is a GUI toolkit for the Python programming language. Pygame is a cross-platform set of Python modules designed for writing video games. It includes computer graphics and sound libraries designed to be used with the Python programming language. Python Imaging Library (PIL) adds image processing capabilities to a Python interpreter.

In a loop, user hand motions and gestures are detected by the LEAP Motion controller 220, 221, and data is transmitted via USB to the computer 224, 225. Motion and gestures are translated to cursor movement, mouse clicks, and keystrokes for PACS control 224, 225. If the system is displayed on a single screen, cursor movement is based on the absolute position of the hand and/or finger in the detection area 224. If the system is displayed on multiple screens, cursor movement is based on the relative motion of the hand and/or finger in the detection area 225. A new detection frame is started, and the program loops to wait for next frame of input 228, 229. The loop is broken when the user pauses or closes the program 232, 233. The program is terminated based on its PID at the OS level 236, 237. At this point, both branches converge to the same termination steps. If termination based on PID fails, the program will attempt to force quit 240. If this fails, an error message is sent 244.

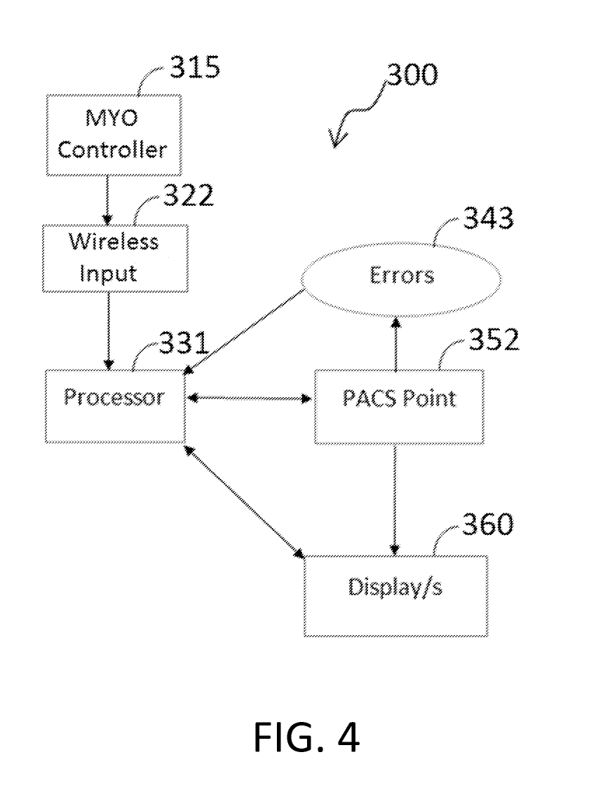

FIG. 4 shows a specific embodiment of such a system 300 where a motion sensing input device, which in this case is a MYO controller 315, is connected to a computer via wireless input 322. The wireless input 322 may be via BLUETOOTH, WLAN, and the like. This wireless input 322 is accessible to a processor 331, which receives data from the wireless input 322, display(s) 360, PACS Point program 352, and errors 343 generated by the PACS Point program 352. PACS Point program 352 consists of computer-readable instructions that can be executed by the processor 331, which affect operations at the OS level, as well as the display 360. The computer-readable instructions can be programmed in any suitable programming language, including JavaScript, C#, C++, Java, Python, and Objective C.

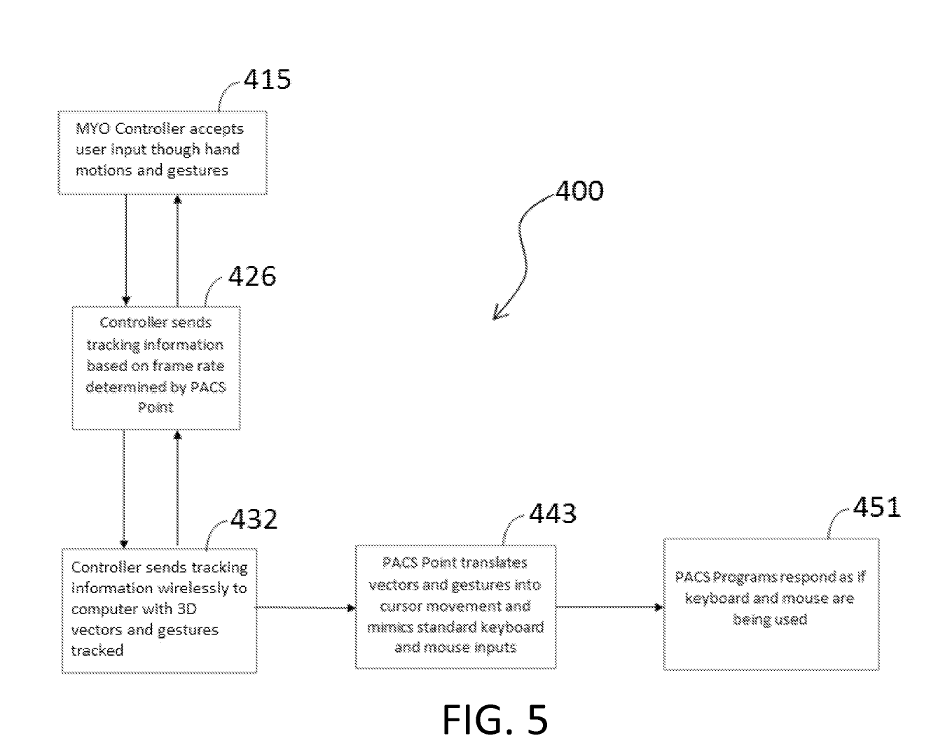

FIG. 5 shows software-level operations 400 of an embodiment of the disclosure using the MYO Controller. The MYO controller accepts user input through hand motions and gestures 415. Associated data is sent via wireless input to a computer as 3D vectors and gestures 432. Example schemes of this tracking include a thumb-to-pinky pinch for zooming, two hands five fingers spread out moving toward/away from each other for zooming, five fingers spread out moving up or down for scrolling, closed first screen tap click for mouse click, one hand wave left or right for keyboard input for next series, and closed first movement for cursor movement. This tracking information is based on a frame rate determined by PACS Point 426. Typically, the highest frame rate possible for a particular component of the system is preferable. PACS Point translates vectors and gestures into cursor movement, mouse clicks, keystrokes, etc., which are emulated at the OS level 443. PACS programs then respond as if keyboard and mouse are used 451.

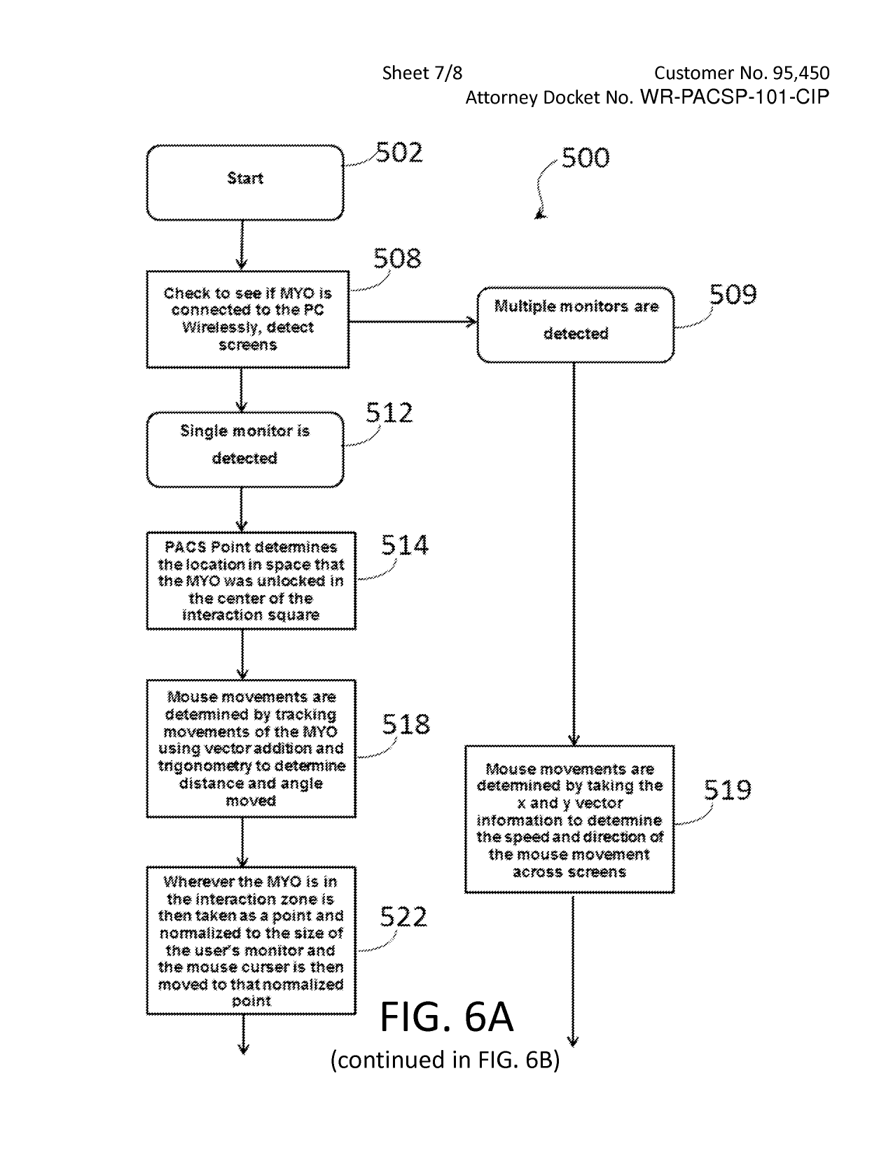

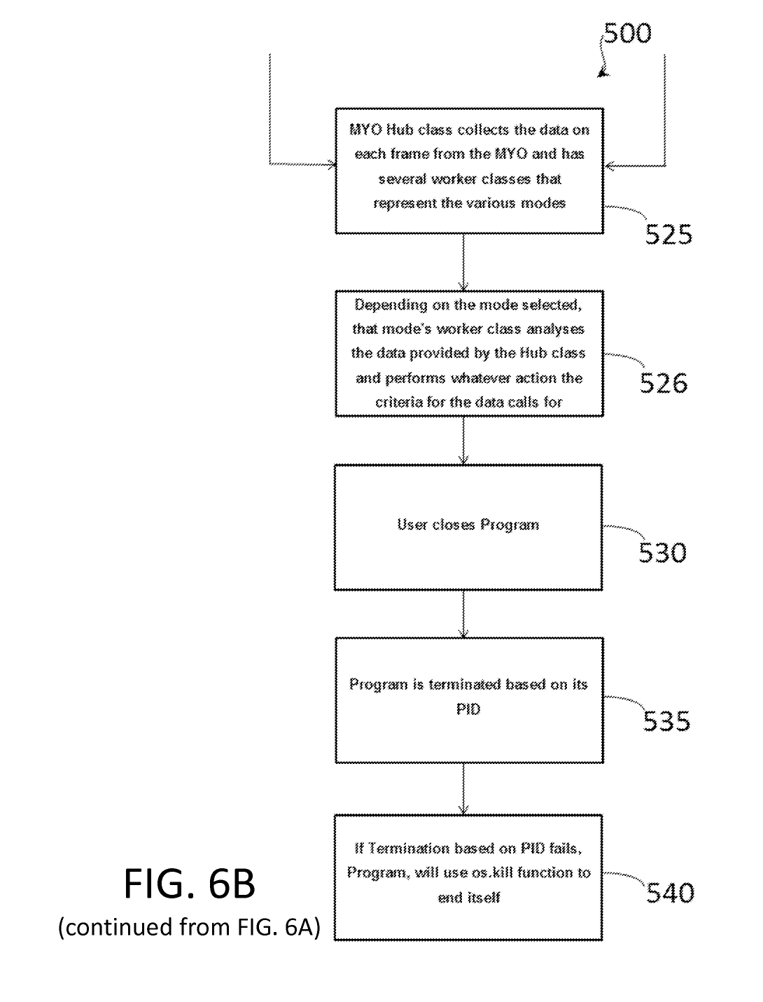

FIGS. 6A and 6B show control flow 500 of an embodiment of a method of this disclosure which may be embodied in a computer program or application. When PACS Point starts 502 it first checks to see if a MYO is connected to the PC wirelessly 508 and if so waits for the user to unlock the device using one of the recognized gestures. Depending on if the program detects a single monitor 512 or multiple monitors 509 the rest of the initialization has different steps. If a single monitor is detected 512, when the user unlocks the device, PACS Point determines that the location in space that the MYO was unlocked is the center of an interaction square 514. When the program is in a mouse movement mode, subsequent movements of the MYO on the arm are tracked using vector addition and trigonometry to determine the distance moved and the angle moved 518. Wherever the MYO is in the interaction zone is then taken as a point and normalized to the size of the user's monitor and the mouse cursor is then moved to that normalized point 522. Additional modes can be cycled through by using the pose recognized as a double tap by the MYO. For instance the scrolling mode can be accessed, where the program looks for changes in the Y-axis vector to determine if the user wants to scroll up or down and then facilitates that action by either simulation a mouse wheel rotation or a keyboard keystroke such as Page Up or Down.

In addition to these separate modes, PACS Point makes use of other recognized poses such as the wave left/right, fist, and fingers spread to control inputs such as left or right mouse button clicks. If multiple monitors are detected 509 at initialization the mouse movement is conducted by taking the x and y axis vector information to determine the speed and direction of the mouse movement across screens 519. Users can lock and unlock the system to make sure unwanted movement does not occur using one of the recognized poses. This system allows the user complete control of the cursor across all monitors. In addition to using the data provided by the poses and vectors PACS Point also can make use of the orientation data to modify the commands of the standard poses. For example a hand that is palm downward making a first may simulate a left mouse click while the same motion with the palm facing upwards would simulate a right mouse click.

The structure of the program is set up so that a MYO Hub class collects the data on each frame from the MYO and has several worker classes that represent the various modes 525. Depending on the mode selected, that mode's worker class analyses the data provided by the Hub class and performs whatever action the criteria from the data calls for 526. PACS Point is intended to run in the background while a user operates imaging software and error handling is conducted in an effort to minimize any interruption. If a frame of data generates an error PACS Point passes over that frame and waits until the next non-error producing frame is available to produce any actions. When the user decides to close PACS Point 530, all processes created by the program are identified by their PID 535 and terminated using the standard sys module of Python. If this fails for any reason the os.kill function is called which will kill the PACS Point process and child processes it created 540. This is done in order to make sure that no left over virtual keystrokes are being read by the operating system.

In specific embodiments of the invention methods of using the software or methods of controlling the PACS system can be used to perform medical procedures in real time. A physician can perform a procedure on a patient while accessing images of the patient's body during the procedure itself, yet while maintaining sterility of the environment in which the patient is undergoing the procedure. For example, a method of guiding a needle or catheter within a patient's body, can comprise: (a) imaging a region of interest of a patient's body with one or more imaging modality to obtain one or more images of the region of interest; (b) accessing the one or more images in a picture archiving and communication system (PACS); (c) navigating the one or more images in the PACS system to locate an image or images showing a position of a needle or a catheter within the patient's body, wherein the navigating is performed using a computer hardware sensor device that supports hand and finger motions as input; and (d) moving the needle or catheter to another position within the patient's body using the one or more images in the PACS system as a guide to desired positioning.

Such methods can comprise navigating of the one or more images which involves one or more of selecting one or more images, selecting a series of images, changing image series, scrolling through image stacks, scrolling through image series stacks, moving a cursor, annotating an image or images, or accessing a tool bar. The navigating is preferably performed while maintaining a sterile environment for the patient, such as by having no physical interaction with a computer. Such navigating of the PACS images is preferably performed directly by the physician intraoperatively.

In preferred embodiments, the physician or healthcare worker can annotate images electronically and without physically interacting with a computer.

The one or more imaging modality can be chosen from one or more of MRI (magnetic resonance imaging), PET (positron emission tomography), CT (computed tomography), X-ray, Ultrasound, Photoacoustic imaging, Fluoroscopy, Echocardiography, or SPECT (single-photon emission computed tomography).

These methods, as well as other specific methods of using the software and image navigating methods of the invention are explained in more detail in the Examples provided below.

### Example 1

The LEAP Motion Controller is designed to recognize hands, fingers, and gestures within its detection cone and to report that information in the form of 3D coordinates and gesture tracking. The LEAP Motion sends this information to the computer via USB. PACS Point works with the LEAP Motion Controller and uses this tracking information to produce commonly used inputs, such as cursor movement and mouse clicks, for medical image viewing programs such as GE PACS. PACS Point is coded in Python v 2.7 and uses several standard Python modules as well as the Python module generated for use with the LEAP Controller. When PACS Point starts it first checks to make sure a LEAP Controller is connected and then determines the size of the display screen. When the controller is found the program sets policy flags that ensure that PACS Point can run in the background when it does not have the computers focus. The LEAP Controller sends information on a frame by frame basis, that can have varying speeds depending on the settings of the controller and the environment it is in. PACS Point calls the on_frame method supplied by the LEAP Python module to receive this information in a continuous loop until the program is closed. The general structure of PACS Point is set up as a two-class program that contains the Listener Class and the standard controller class supplied by LEAP. The Listener class is customized to receive the information from the controller class and then act on the information received. The design of the Listener class was done with blocks of if statements checking for various conditions in the information received from the controller, and then modifying the results of that input as needed.

The Listener class will first check for the number of fingers within the controller's detection cone. This number will determine which if statement block the rest of the incoming information should be read by. For example if the incoming information shows that there are 5 fingers within the detection cone the Listener class will then look at the direction and the position of the palm of that hand. Depending on the direction and the position of the palm the Listener class will then generate a virtual keystroke that is recognized by the operating system (i.e. Windows) and is treated the same way as a physical keystroke would be. Depending on the imaging program that is being run with PACS Point, if PACS Point detects 5 fingers in the detection cone it will generate the keystroke needed to control screen scrolling in the desired direction. Controlling the cursor with PACS Point is done by moving one finger into the detection cone of the controller. The if statement block for one finger will take the screen size determined upon initialization of the program and acquire the 2-D position of the finger-tip position. Using the LEAP API's built in translation probability attribute as a filter to reduce stuttering, PACS Point will send the 2-D position values to an algorithm based on screen size to produce coordinates for the mouse to move to. This can be done by either moving the cursor to the position on the display corresponding to the 2-D position detected by the LEAP controller or by moving the cursor at a velocity proportional to a position vector of this 2-D position. If a finger-tip is detected in the top right corner of the controller's detection cone, the cursor will move to the top right corner of the display screen. These coordinate values are constantly updated by the frames of data the LEAP Controller sends, which allows for smooth cursor movement during use.

The LEAP Controller is capable of recognizing several gestures including, what are known as keytaps, screentaps, swipes, and circles. When a gesture is recognized by the LEAP Controller it is reported to PACS Point with the gesture type and the gesture progress on a frame by frame basis. PACS Point's gesture system is designed to work when 1, 2, or 3 fingers are detected in the controller's cone. If PACS Point determines that there are 2 fingers in the cone, the cursor will stop moving and the program will wait to see if a gesture is made. If the user taps their fingers towards the screen, PACS Point will register that gesture as a screen tap, and will simulate a Left-button mouse click, which is recognized by the operating system as equivalent to a physical Left-button mouse click. If 3 fingers are detected and the same motion is repeated, PACS Point will simulate a Left-mouse button hold that is useful for drag-and-drop operations. If only 1 finger is detected, PACS Point will not look for the screen tap gesture, but will instead look for a keytap which is a downward motion similar to typing on a keyboard. If a keytap is registered, PACS Point will simulate the keystroke needed to bring up the toolbar, depending on the imaging program that it is being run with (i.e. Right-button mouse click with GE PACS). Errors are handled at the end of the customized on_frame class method and will generally tell PACS Point to go back to the last good frame of data and wait until another good frame of data is available. This system of error handling is also designed to reduce cursor stuttering. When the user decides to close PACS Point, all processes created by the program are identified by their PID and terminated using the standard sys module of Python. If this fails for any reason the os.kill function is called which will kill the PACS Point process and child processes it created. This is done in order to make sure that no left over virtual keystrokes are being read by the operating system.

### Example 2

### Image-Guided Biopsies

The software may allow the physician to directly navigate and/or manipulate images in PACS using the controller connected to a scanner or associated PACS computer. The physician will be able to select particular images, select particular series, change series, scroll through image stacks, scroll through series stacks, move the cursor, window and level the image, annotate the images, bring up the tool bar, adjust and change the PACS preferences, refresh screen, minimize the PACS screen and close PACS all without using a mouse or keyboard. This would allow the physician to maintain sterility throughout the procedure. The physician would use the service to guide the needle through the patient's body or tissue to the correct position without using a mouse/keyboard to navigate to the relevant image or without having to direct an assistant to the right image. The needle position will be able to seen on the images selected by the touch free technology. The physician will be able to scroll through as many needed images as required to find the needle position to accurately pinpoint its location without the use of a mouse or keyboard, thereby maintaining sterility throughout the entire procedure. The inventors have found that for a user, such as a physician, to localize 10 individual images by directing a technologist averaged 3.75 minutes. A physician using the touch-free device localizing the same 10 images averaged 1.50 minutes, which represents a decrease in image localization by over 50%.

### Example 3

### Image-Guided Drain Placement

The software may allow the physician to directly manipulate the images via the controller connected to an MRI/CT scanner or associated PACS computer. This will allow the physician to retain sterility throughout the procedure. The physician will use the service to guide the drainage catheter to the correction position without the need of a mouse/keyboard and without having to direct an assistant to the right image. The images will be able to be scrolled through to find the needle position by using a palm open gesture over the LEAP controller. The hand will be moved up to scroll upwards through the images and moved down to scroll down through the images. The cursor will be moved by extending the index finger over the LEAP controller and moving it through the air. The tool box will be brought up by tap downwards in the air with the index finger. Any tool or image in the toolbar may be selected by extending both the index finger and thumb and simulating a push forward over the controller. Image rotation, refreshing screen, and image inversion can then be selected by moving the index finger through the air until the cursor is placed over the appropriate function button. The button is then selected by extending both the index finger and thumb over the controller and pushing forward over the controller. Drag/drop functionality will be performed by extending three fingers over the controller and pushing forward. This will allow a user to initiate PACS functions such as length measurements and region of interest analysis if radiologic Hounsfield unit measurements are required. This is currently implemented and has decreased image localization by over 50%.

### Example 4

### Touch-Free Image Manipulation/Marking

The service will allow physicians to manipulate any PACS system and aid in image interpretation. This will allow the physician to not only scroll through any series and image number but to manipulate and mark the DICOM data without physically touching a mouse or keyboard. DICOM (digital imaging and communications in medicine) data is a standard for storing and transmitting information in medical imaging and enables the integration of various types of scanners into PACS. Marking is performed by opening the toolbox, which is performed by pushing the index finger downward over the LEAP controller. Any tool can then be selected by extending the index finger and thumb and pushing forward over the controller. The initiation of ruler, annotation arrow, text box, magnification tool, window tool, and region of interest or level tool is initiated by extending 3 fingers over the controller and pushing forward.

### Example 5

### Touch-Free Imaging Education

The service will allow a healthcare professional to manipulate any DICOM imaging for the purpose of education touch free. This would allow the training professional to remain in a sterile environment. This will also allow any trainees to manipulate the imaging data and also remain sterile throughout the process.

### Example 6

### Touch-Free Image-Guided Surgical Intervention

The service will allow the physician to manipulate images intraoperatively and not only be able to remain sterile but not rely on an assistant to manipulate the images. In most current practices, the physician has to verbally direct the technologists to scroll through images, draw arrows, draw regions of interest, change series, change image and draw length measurements so that the physician may maintain sterility throughout the procedure. The software will enable the physician to manipulate the images in any way as currently practiced by moving their hand over the LEAP controller to manipulate the images and remain sterile. This will increase patient safety by reducing the risk of infection, reducing anesthesia time and reduce cost by reducing operating room time.

### Example 7

### Touch-Free Image-Guided Endovascular Intervention

The software will allow the physician to directly manipulate the images by way of a controller connected to the scanner or associated PACS computer. This will allow the physician to retain sterility throughout the procedure. The physician will use the service to evaluate the fluoroscopic and digital images to aid in vascular anatomy interpretation, vascular pathology and endovascular intervention without the use of a mouse/keyboard and without having to direct an assistant to the right image.

### Example 8

### Image-Guided Biopsies

The software may allow the physician to directly navigate and/or manipulate images in PACS using the controller connected to a scanner or associated PACS computer as in Example 2, except in this Example the MYO controller is used as the motion-sensing input device. The MYO controller is worn by the physician on the wrist or forearm and the PACS Point software detects hand gestures and translates them into mouse or cursor movements to navigate or manipulate images in PACS in the context of Example 2. In this Example, wave left is translated by the PACS Point program as left mouse click and a wave right is translated by the program as a right mouse click. The simulated mouse clicks allows the physician to select an image without the use of a mouse or keyboard.

### Example 9

### Image-Guided Drain Placement

The software may allow the physician to directly manipulate the images via the controller connected to an MRI/CT scanner or associated PACS computer as in Example 3, except in this Example the MYO controller is used as the motion-sensing input device. The MYO controller is worn by the physician on the wrist or forearm and the PACS Point software detects hand gestures and translates them into mouse or cursor movements to navigate or manipulate images in PACS in the context of Example 3. In this example, spreading the fingers is translated by the PACS Point program as scrolling upward, and a closed first is translated by the program as scrolling downward. The simulated scrolling allows the physician to scroll upward or downward through the images without the use of a mouse or keyboard.

### Example 10

### Touch-Free Image Manipulation/Marking

The service will allow physicians to manipulate any PACS system and aid in image interpretation as in Example 4, except in this Example one or more EMG sensors are used as the motion sensing input device. The one or more EMG sensors are worn by the physician on the wrist or forearm and the PACS software detects hand gestures and translates them into mouse or cursor movements to navigate or manipulate images in PACS in the context of Example 4. In this Example, extending the hand palm downward and waving left is translated by the PACS Point program as a left mouse click, and extending the hand palm upward and waving right is translated by the program as a right mouse click. The simulated mouse clicks call up a virtual keyboard and menu on the screen, allowing the physician to annotate the images without physically touching a mouse or keyboard.

### Example 11

### Touch-Free Imaging Education

The service will allow a healthcare professional to manipulate any DICOM imaging for the purpose of education touch free as in Example 5, except in this Example the MYO controller is used as the motion-sensing input device. The MYO controller is worn by the physician on the wrist or forearm and the PACS software detects hand gestures and translates them into mouse or cursor movements to navigate or manipulate images in the DICOM viewer in the context of Example 5. In this Example, extending a closed first is translated by the PACS Point program as scrolling upward, and retracting a closed first is translated by the program as scrolling downward. The simulated scrolling moves the image upward or downward on the screen thus allowing the physician to display different parts of the image in the DICOM viewer without physically touching a mouse or keyboard.

### Example 12

### Touch-Free Image-Guided Surgical Intervention

As in Example 6, the service will allow the physician to manipulate images intraoperatively and not only be able to remain sterile but not rely on an assistant to manipulate the images, except in this Example one or more EMG sensors are used as the motion-sensing input device. The one or more EMG sensors are worn by the physician on the wrist or forearm and the PACS Point software detects hand gestures and translates them into mouse or cursor movements to navigate or manipulate images in PACS in the context of Example 6. In this Example, extending the hand fingers downward is translated by the PACS Point program as a left mouse double-click, and extending the hand fingers upward is translated by the PACS Point program as a right mouse double-click. The simulated left mouse double-click and right mouse double-click call up different menus in PACS that allow the physician to manipulate the images without the use of a mouse or keyboard.

### Example 13

### Touch-Free Image-Guided Endovascular Intervention

As in Example 7, the software will allow the physician to directly manipulate the images by way of a controller connected to the scanner or associated PACS computer, except in this Example the MYO controller is used as the motion-sensing input device. The MYO controller is worn by the physician on the wrist or forearm and the PACS Point software detects hand gestures and translates them into mouse or cursor movements to navigate or manipulate images in PACS in the context of Example 7. In this Example, thumb-to-pinky is translated by the PACS Point software as zooming in, and spread fingers are translated as zooming out. This allows the physician to zoom in or out on anatomical features in the image without the use of a mouse or keyboard.

The present invention has been described with reference to particular embodiments having various features. In light of the disclosure provided, it will be apparent to those skilled in the art that various modifications and variations can be made in the practice of the present invention without departing from the scope or spirit of the invention. One skilled in the art will recognize that the disclosed features may be used singularly, in any combination, or omitted based on the requirements and specifications of a given application or design. When an embodiment refers to “comprising” certain features, it is to be understood that the embodiments can alternatively “consist of” or “consist essentially of” any one or more of the features. Other embodiments of the invention will be apparent to those skilled in the art from consideration of the specification and practice of the invention.

It is noted that the singular forms “a,” “an,” and “the” include plural referents unless the context clearly dictates otherwise. It is intended that the specification and examples be considered as exemplary in nature and that variations that do not depart from the essence of the invention fall within the scope of the invention. Further, all of the references cited in this disclosure are each individually incorporated by reference herein in their entireties and as such are intended to provide an efficient way of supplementing the enabling disclosure of this invention as well as provide background detailing the level of ordinary skill in the art.

1. A computer-readable storage device comprising computer-executable instructions configured to direct a first processing module to:
receive hand position, vector, or gesture information according to a specified frame rate;
translate the hand position, vector, or gesture information into one or more key strokes, mouse clicks, scrolling, or cursor movements; and
navigate, annotate, or modify one or more images in a picture archiving and communication system (PACS) by instructing the system that the one or more key strokes, mouse clicks, scrolling, or cursor movements have been performed;
wherein the hand gesture information is interpreted from information received from one or more sensors each of which are capable of measuring muscle electrical activity.

2. The computer-readable storage device of claim 1, wherein the one or more sensors each of which are capable of measuring muscle electrical activity are EMG sensors.

3. The computer-readable storage device of claim 2, wherein the hand position or vector information is interpreted from information received from at least one of a three-axis gyroscope, three-axis accelerometer, and a three-axis magnetometer.

4. The computer-readable storage device of claim 3, wherein the hand position, vector, or gesture information is interpreted by a second processing module.

5. The computer-readable storage device of claim 1 wherein the computer-executable instructions provide a first class and a second class, and the hand position, vector, or gesture information of a frame is received by the first class and analyzed by the second class.

6. The computer-readable storage device of claim 5, wherein the second class is associated with a user-selected mode comprising keyboard input, mouse position, scrolling, or mouse clicks.

7. The computer-readable storage device of claim 5, wherein the second class executes one or more key strokes, mouse clicks, scrolling, or cursor movements based on the analysis of the data received by the first class.

8. A computer-implemented method of controlling a picture archiving and communication system (PACS) without physical contact with a computer or computer accessory, the method comprising:
receiving hand position, vector, or gesture information according to a specified frame rate;
translating the hand position, vector, or gesture information into one or more key strokes, mouse clicks, scrolling, or cursor movements; and
navigating, annotating, or modifying one or more images in a picture archiving and communication system (PACS) by instructing the system that the one or more key strokes, mouse clicks, scrolling, or cursor movements have been performed,
wherein the receiving, translating, and navigating steps are performed through a first processing module; and
wherein the hand gesture information is interpreted from information received from one or more sensors each of which are capable of measuring muscle electrical activity.

9. The computer-implemented method of claim 8, wherein the one or more sensors each of which are capable of measuring muscle electrical activity are EMG sensors.

10. The computer-implemented method of claim 9, wherein the hand position or vector information is interpreted from information received from at least one of a three-axis gyroscope, three-axis accelerometer, and a three-axis magnetometer.

11. The computer-implemented method of claim 10, wherein the hand position, vector, or gesture information is interpreted by a second processing module.

12. The computer-implemented method of claim 8, wherein the translating step is performed by a set of computer-executable instructions providing a first class and a second class, and the hand position, vector, or gesture information of a frame is received by the first class and analyzed by the second class.

13. The computer-readable storage device of claim 12 wherein the second class is associated with a user-selected mode comprising keyboard input, mouse position, scrolling, or mouse clicks.

14. The computer-readable storage device of claim 12, wherein the second class executes one or more key strokes, mouse clicks, scrolling, or cursor movements based on the analysis of the data received by the first class.

15. A method of guiding a needle or catheter within a patient's body, the method comprising:
imaging a region of interest of a patient's body with one or more imaging modality to obtain one or more images of the region of interest;
accessing the one or more images in a picture archiving and communication system (PACS);
navigating the one or more images in the PACS system to locate an image or images showing a position of a needle or a catheter within the patient's body, wherein the navigating is performed using one or more EMG sensors; and
moving the needle or catheter to another position within the patient's body using the one or more images in the PACS system as a guide to desired positioning.

16. The method of claim 15, wherein the navigating is performed using at least one of a three-axis gyroscope, three-axis accelerometer, and a three-axis magnetometer.

17. The method of claim 15, wherein the navigating of the one or more images involves one or more of selecting one or more images, selecting a series of images, changing image series, scrolling through image stacks, scrolling through image series stacks, moving a cursor, annotating an image or images, or accessing a tool bar.

18. The method of claim 15, wherein the navigating is performed while maintaining a sterile environment for the patient by having no physical interaction with a computer.

19. The method of claim 15, wherein the annotating involves electronically marking the one or more images without physically interacting with a computer.

20. The method of claim 15, wherein the one or more imaging modality is chosen from one or more of MRI (magnetic resonance imaging), PET (positron emission tomography), CT (computed tomography), X-ray, Ultrasound, Photoacoustic imaging, Fluoroscopy, Echocardiography, or SPECT (single-photon emission computed tomography).
